(19) United States
(12) Patent Application Publication
(10) Pub. No.: US 2026/0339116 A1
(43) Pub. Date: Oct. 29, 2026

(54) LIGHT FIELD 3D DISPLAY APPARATUS AND LIGHT FIELD 3D DISPLAY METHOD

(71) Applicant: BEIHANG UNIVERSITY, Beijing (CN)

(72) Inventors: Yan XING, Beijing (CN); Qionghua WANG, Beijing (CN); Xingyu LIN, Beijing (CN); Chengbo ZHAO, Beijing (CN); Fan CHU, Beijing (CN); Minhao XIANG, Beijing (CN); Kefeng TU, Beijing (CN)

(21) Appl. No.: 19/268,136

(22) Filed: Jul. 14, 2025

(30) Foreign Application Priority Data
Apr. 28, 2025 (CN) 202510541090.3

(51) Int. Cl. G02B 30/27

(52) U.S. Cl. CPC G02B 30/27

(57) ABSTRACT

A light field 3D display apparatus and a light field 3D display method are provided. The light field 3D display apparatus includes a directional light-emitting 2D display screen configured to emit a plurality of first light rays, a lenticular lens array configured to directionally modulate the plurality of first light rays emitted by the directional light-emitting 2D display screen, and an optical diffusion screen configured to perform small-angle diffusion of a plurality of second light rays in a one-dimensional direction. The directional light-emitting 2D display screen, the lenticular lens array, and the optical diffusion screen are sequentially arranged in a laminated manner, and configured to perform directional modulation and small-angle diffusion of directional light rays emitted from the directional light-emitting 2D display screen in the one-dimensional direction, so as to reconstruct a complete discrete light field and obtain continuous 3D images.

### CROSS-REFERENCE TO RELATED APPLICATIONS

This application claims priority under 35 U.S.C. § 119(a) to Chinese Patent Application No. 202510541090.3, filed on Apr. 28, 2025, which is hereby incorporated by reference herein in its entirety.

### TECHNICAL FIELD

The present disclosure relates to the technical field of 3D display, and in particular to a light field 3D display apparatus and a light field 3D display method.

### BACKGROUND ART

Light field 3D display is a display technology used to present 3D images by reconstructing a light intensity distribution of objects in free space, which enables to reconstruct high-dimensional light ray data aligning with stereoscopic visual characteristics of human eyes, accurately represent occlusion relationships between different objects, and achieve a natural and comfortable stereoscopic perception effect. A resolution, a viewing angle, and a depth are three important performance parameters of a light field 3D display apparatus, but light field 3D display apparatuses disclosed cannot achieve both a high resolution and a large depth range in a relatively large viewing-angle range. Due to mutual constraints between the three performance parameters, a single performance parameter is typically optimized according to previously disclosed technical solutions, and other performance parameters are ignored, thereby making it difficult to adequately meet viewing and use requirements.

### SUMMARY

An objective of the present disclosure is to provide a light field 3D display apparatus and a light field 3D display method, and the light field 3D display apparatus achieves both a high resolution and a large depth range in a relatively large viewing-angle range.

In a first aspect, the present disclosure provides a light field 3D display apparatus, including: a directional light-emitting 2D display screen arranged at a bottom layer of the light field 3D display apparatus, where the directional light-emitting 2D display screen is configured to emit a plurality of first light rays, and the plurality of first light rays carry positional and directional information of a light field, and form a light beam with a first divergence angle; a lenticular lens array, where the lenticular lens array is attached to one surface of the directional light-emitting 2D display screen, and placed aslant relative to the directional light-emitting 2D display screen, and the lenticular lens array is configured to directionally modulate the plurality of first light rays emitted by the directional light-emitting 2D display screen, to form a plurality of second light rays that reconstruct a discrete light field; and an optical diffusion screen arranged on the other side of the lenticular lens array, where the optical diffusion screen is configured to diffuse the plurality of second light rays in a one-dimensional direction to form a light beam with a second divergence angle, such that 3D images corresponding to the discrete light field become spatially continuous.

In some examples, the first divergence angle is any one of ±2°, ±3°, and ±5°, and the second divergence angle is any one of 3.5°, 5°, and 6.5°.

In some examples, the directional light-emitting 2D display screen emits light in a passive manner, and the directional light-emitting 2D display screen emitting light in the passive manner includes: a backlight module, where the backlight module includes a light source layer, a micro-lens array, and a freeform surface lens array that are sequentially arranged, a surface profile of a lens element of the micro-lens array is selected from any one of a freeform surface and an aspheric surface, and a surface profile of a lens element of the freeform surface lens array is selected from any one of a freeform surface and a freeform Fresnel surface; and a liquid crystal panel, where the liquid crystal panel includes a plurality of sub-pixels arranged in a rectangular and strip-shaped manner, each of the plurality of sub-pixels has a color selected from any one of red, green, blue, and white, and a plurality of sub-pixels of different colors collectively form a single color pixel of the liquid crystal panel.

In some examples, the directional light-emitting 2D display screen emits light in an active manner, and the directional light-emitting 2D display screen emitting light in the active manner includes: a display layer, where a plurality of sub-pixels are arranged on the display layer, the sub-pixels are configured to achieve active emission through electroluminescence or an inorganic semiconductor, each of the plurality of sub-pixels has a color selected from any one of red, green, blue, and white, and a plurality of sub-pixels of different colors collectively form a single color pixel of the display layer; and a light beam directing layer, where the light beam directing layer is integrated on one side of a light-emitting surface of the display layer, including a micro-lens array and a freeform surface lens array that are sequentially arranged, and a lens element in the micro-lens array or the freeform surface lens array is arranged to correspond to a plurality of pixels or an individual pixel of the display layer.

In some examples, the lenticular lens array is formed by arranging a plurality of lenticular lens elements at an equal interval in a one-dimensional direction, and a cross-sectional surface profile of the lenticular lens element is a freeform surface or an aspheric surface.

In some examples, a function distribution of light intensity modulation by the optical diffusion screen is a Gaussian distribution or flat-top distribution, and a direction of diffusing the plurality of second light rays through the optical diffusion screen aligns with a direction of arranging the lenticular lens elements on the lenticular lens array.

In a second aspect, the present disclosure provides a light field 3D display method, including: a plurality of first light rays are emitted from the directional light-emitting 2D display screen, where the plurality of first light rays form a light beam with a first divergence angle, and the first divergence angle is any one of ±2°, +3°, and +5°; the lenticular lens array is configured to directionally modulate the plurality of first light rays emitted by the directional light-emitting 2D display screen, and the plurality of first light rays converge at a focal point of each lenticular lens element of the lenticular lens array, to form a plurality of second light rays that reconstruct a discrete light field, where the lenticular lens array is placed aslant relative to the directional light-emitting 2D display screen, and the lenticular lens array is formed by arranging a plurality of lenticular lens elements at an equal interval in the one-dimensional direction; and the optical diffusion screen is configured to diffuse the plurality of second light rays in the one-dimensional direction to form a light beam with a second divergence angle, such that 3D images corresponding to the discrete light field become spatially continuous, and a direction of diffusing the plurality of second light rays through the optical diffusion screen aligns with a direction of arranging the lenticular lens elements on the lenticular lens array.

In some examples, a width of image patches on an incident surface of the optical diffusion screen is less than a width of the sub-pixels of the directional light-emitting 2D display screen, and a width direction of the image patches on the incident surface of the optical diffusion screen aligns with an array direction of the lenticular lens array; and the width of image patches on the light-emitting surface of the optical diffusion screen is less than or equal to a pitch of the lenticular lens array, and the width direction of the image patches on the light-emitting surface of the optical diffusion screen aligns with the array direction of the lenticular lens array.

In some examples, the directional light-emitting 2D display screen is loaded with a 3D image source, a resolution of the 3D image source is identical to a resolution of the directional light-emitting 2D display screen, the 3D image source includes a plurality of combinations of the sub-pixels with different intensity values, and light rays formed by the plurality of combinations of the sub-pixels converge at predetermined specified distances to form a plurality of viewpoints, where the viewpoints are arrayed at an equal interval; and a spacing between adjacent viewpoints is less than an average pupil diameter, such that a pupil receives information from at least two viewpoints simultaneously, thereby providing depth cues for monocular focus adjustment.

In some examples, all the viewpoints are traversed, each of the viewpoints corresponds to a light ray, and the light rays collectively partition the sub-pixels into a plurality of image elements; each of the image elements corresponds to at least two lenticular lens elements in the array direction of the lenticular lens array; each of the image elements corresponds to at least two rows of pixels or at least two columns of sub-pixels of the directional light-emitting 2D display screen in a vertical array direction of the lenticular lens array; and each sub-pixel of the image element is arranged at varying distances from a same edge of a corresponding lenticular lens element.

In the light field 3D display apparatus of the present disclosure, the directional light-emitting 2D display screen arranged at the bottom layer emits light rays with high directionality, a small divergence angle, and high uniformity, and the light rays carry positional and directional information of light field. After directional modulation by each lenticular lens element of the lenticular lens array, the light rays converge at a focal point of each lenticular lens element, and then undergo small-angle diffusion in the one-dimensional direction through the optical diffusion screen. Light rays from different directions carrying information of a same 3D image point, converge at a reproduction position corresponding to the 3D image point, to reconstruct a complete discrete light field. Finally, the light rays continue to propagate forward, thereby forming a 3D display effect with a wide viewing angle, a high resolution, and a large depth range. The lenticular lens array is capable of deflecting light rays to specified positions in space over a wide range, thereby achieving a larger viewing-angle range; and the lenticular lens array precisely modulates the direction of light rays, such that the one-dimensional size of the 3D image points in the array direction of the lenticular lens element is less than or equal to the pitch of the lenticular lens array, thereby ensuring the high resolution and the large depth range. The optical diffusion screen is configured to perform small-angle diffusion of light rays modulated by the lenticular lens array in the one-dimensional direction, such that 3D images are visually continuous, without noticeable breakage or discontinuity. Densely distributed and numerous viewpoints are constructed by the light field 3D display apparatus of the present disclosure, which enables to monocularly receive information of at least two viewpoints simultaneously, and ensures that human eyes perceive stereoscopic property properly in the viewing-angle range through cues for monocular focus adjustment, monocular motion parallax, and binocular parallax. The light field 3D display apparatus of the present disclosure, through coordinated arrangement of the directional light-emitting 2D display screen, the lenticular lens array, and the optical diffusion screen, achieves both a high resolution and a large depth range in a relatively large viewing-angle range, and alleviates mutual restrictions of conventional light field 3D display apparatuses in performance parameters such as the resolution, viewing angle, and depth.

### BRIEF DESCRIPTION OF THE DRAWINGS

The above aspects and advantages of the present disclosure will become further apparent and easier to understand from the detailed description of examples in combination with the accompanying drawings below:

FIG. 1 is an oblique view of an internal structure of a light field 3D display apparatus according to an example of the present disclosure.

FIG. 2 is an oblique view of an internal structure of a directional light-emitting 2D display screen according to an example of the present disclosure.

FIG. 3 is a side view of an internal structure of a backlight module according to an example of the present disclosure.

FIG. 4 is a side view of light rays modulated by a liquid crystal panel according to an example of the present disclosure.

FIG. 5 is a top view of a lenticular lens array placed aslant relative to a directional light-emitting 2D display screen according to an example of the present disclosure.

FIG. 6 is a side view of distribution of a discrete light field reconstructed by a light field 3D display apparatus according to an example of the present disclosure.

FIG. 7 is a side view of viewpoint arrangement according to an example of the present disclosure.

FIG. 8A is a side view illustrating correspondence between a single viewpoint and a sub-pixel according to an example of the present disclosure.

FIG. 8B is a schematic diagram of sub-pixels contained in a single image element according to an example of the present disclosure.

FIG. 9 is a top view illustrating correspondence between an image element and a lenticular lens element according to an example of the present disclosure.

FIG. 10 is a side view of a viewing-angle range according to an example of the present disclosure.

FIG. 11A is a side view of light rays received by a viewer I at a depth zi according to an example of the present disclosure.

FIG. 11B is a side view of light rays received by a viewer II at a depth z₂ according to an example of the present disclosure.

It should be understood that the above accompanying drawings are only schematic and are not drawn to scale.

### DETAILED DESCRIPTION

Examples of a light field 3D display apparatus and a light field 3D display method provided by the present disclosure are described in detail below to further illustrate the present disclosure. The following examples are intended solely for further explanation of the present disclosure and should not be construed as a limitation on the protection scope of the present disclosure. Some non-essential improvements and adjustments made by those skilled in the art according to the content of the present disclosure still fall within the protection scope of the present disclosure.

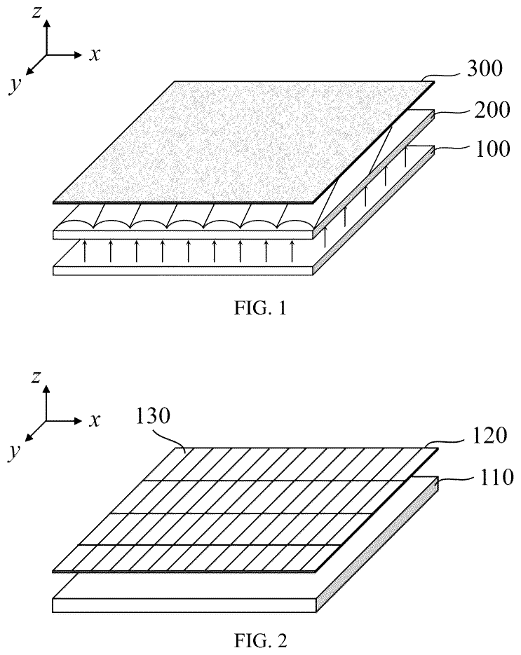

In a first aspect, the present disclosure provides a light field 3D display apparatus. As shown in FIG. 1, the light field 3D display apparatus includes a directional light-emitting 2D display screen 100, a lenticular lens array 200, and an optical diffusion screen 300. In some examples of the light field 3D display apparatus according to the present disclosure, the directional light-emitting 2D display screen 100 is arranged at a bottom layer of the light field 3D display apparatus, and the directional light-emitting 2D display screen 100 is configured to emit a plurality of first light rays, where the plurality of first light rays form a light beam with a first divergence angle; the lenticular lens array 200 is arranged to be attached to one surface of the directional light-emitting 2D display screen 100 and placed aslant relative to the directional light-emitting 2D display screen 100, where the lenticular lens array 200 is configured to directionally modulate the plurality of first light rays emitted by the directional light-emitting 2D display screen 100, to form a plurality of second light rays that reconstruct a discrete light field; and the optical diffusion screen 300 is arranged on the other side of the lenticular lens array 200, and the optical diffusion screen 300 is configured to diffuse the plurality of second light rays in a one-dimensional direction to form a light beam with a second divergence angle, such that 3D images corresponding to the discrete light field become spatially continuous. In some examples, a second divergence angle of light beam diffused in the one-dimensional direction may be 3.5°, 5°, or 6.5°, and preferably, the second divergence angle is 5°. Consequently, light rays emitted by the directional light-emitting 2D display screen 100 are directionally modulated based on light rays from the lenticular lens array 200, and the optical diffusion screen 300 performs small-angle diffusion of directionally modulated light rays in the one-dimensional direction, such that the light rays are finally emitted from the optical diffusion screen and received by human eyes, thereby forming a 3D display effect with a wide viewing angle, a high resolution, and a large depth range.

According to an example of the light field 3D display apparatus as shown in FIG. 1, the directional light-emitting 2D display screen 100 is arranged at the bottom layer of the light field 3D display apparatus, the lenticular lens array 200 is arranged at a middle layer of the light field 3D display apparatus, and the optical diffusion screen 300 is arranged at a top layer of the light field 3D display apparatus, such that light rays emitted from a light source are sequentially modulated. However, those skilled in the art should understand that a laminated structure shown in FIG. 1 that the directional light-emitting 2D display screen 100, the lenticular lens array 200, and the optical diffusion screen 300 of the light field 3D display apparatus are sequentially arranged from bottom to top is merely exemplary, and the directional light-emitting 2D display screen 100, the lenticular lens array 200, and the optical diffusion screen 300 are alternatively sequentially arranged in any directional sequence, e.g., the directional light-emitting 2D display screen 100, the lenticular lens array 200, and the optical diffusion screen 300 are sequentially arranged from left to right or from right to left in a laminated manner.

In some examples, the directional light-emitting 2D display screen 100 is a highly-directional light-emitting 2D display screen, and is capable of emitting directional light beams with extremely small divergence angles, that is, a plurality of first light rays emitted from the highly-directional light-emitting 2D display screen exhibit high directionality, and propagate substantially in a specific direction with a very small divergence angle. In some examples, the divergence angle may be +2°, +3°, or +5°. Each light ray emitted from each pixel or sub-pixel of the highly-directional light-emitting 2D display screen carries positional and directional information of light field, such that information of the light field is precisely represented.

In some examples, the directional light-emitting 2D display screen 100 may emit light in a passive or active manner.

FIG. 2 illustrates an internal structure of the directional light-emitting 2D display screen 100 emitting light in a passive manner. As shown in the figure, the directional light-emitting 2D display screen 100 in some examples may be a liquid crystal display, including a backlight module 110 and a liquid crystal panel 120. A minimum light-emitting unit of the directional light-emitting 2D display screen 100 is formed by sub-pixels 130 on the liquid crystal panel 120, where a plurality of the sub-pixels 130 are arranged on the liquid crystal panel 120 in a rectangular and strip-shaped manner, and a plurality of the sub-pixels 130 of different colors form a single color pixel. In some examples, colors of the sub-pixels 130 are red (R), green (G), and blue (B), that is, each pixel is composed of sub-pixels of RGB. In some alternative examples, colors of the sub-pixels 130 may be red (R), green (G), blue (B), and white (W), that is, each pixel is composed of sub-pixels of RGBW.

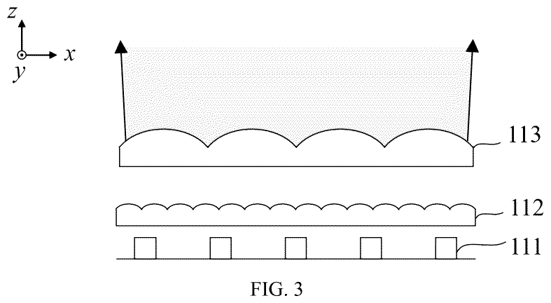

In some examples, the backlight module 110 is a directional backlight module configured to emit backlight with high directionality, a small divergence angle, and high uniformity, where a backlight emission direction is orthogonal to a plane of the backlight module 110, the divergence angle of light beam may be +2°, +3°, or +5°, and the uniformity of light beam may be 90%, 95%, or 98%. As shown in FIG. 3, the backlight module 110 includes a light source layer 111, a micro-lens array 112, and a freeform surface lens array 113, where the light source layer 111, the micro-lens array 112, and the freeform surface lens array 113 are sequentially arranged from bottom to top in a laminated manner. Of course, sequential and laminated arrangement of the light source layer 111, the micro-lens array 112, and the freeform surface lens array 113 shown in FIG. 3 is merely exemplary, and the light source layer 111, the micro-lens array 112, and the freeform surface lens array 113 may be sequentially arranged in any other directional sequence (e.g., from left to right or from right to left). In some examples, the light source layer 111 includes, but is not limited to, a white-light MiniLED array and a white-light LED array. In some examples, a surface profile of a lens element of the micro-lens array 112 includes but is not limited to a freeform surface and an aspheric surface, which is configured to homogenize light rays emitted from the light source layer 111. In some examples, a surface profile of a lens element of the freeform surface lens array 113 includes but is not limited to a freeform surface and a freeform Fresnel surface, which is configured to collimate light rays passing through the micro-lens array 112, and finally converting large-angle scattered light into a small-angle light beam, where the small-angle light beam has a divergence angle of +2°, ±3°, or +5°as described above.

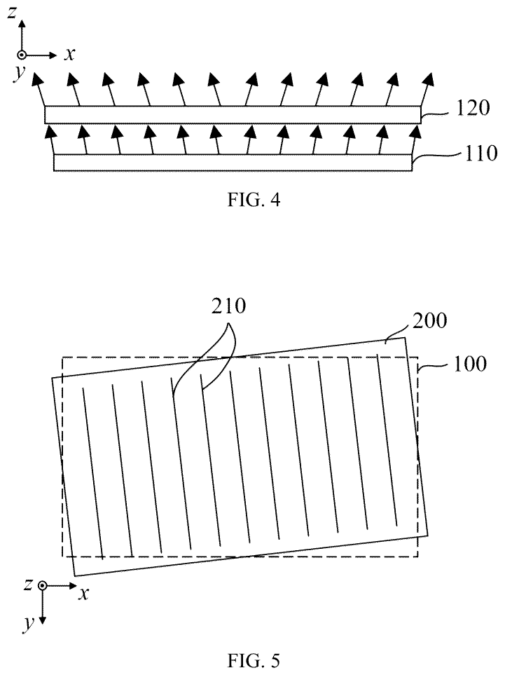

As shown in FIG. 4, the liquid crystal panel 120 is configured to change transmittance of light rays emitted from the backlight module 110, and modulate light intensity. Light rays with high directionality, a small divergence angle, and high uniformity emitted from the backlight module 110 are projected onto the liquid crystal panel 120, and the liquid crystal panel 120 loads a 3D image source recording the light field information. A light ray modulated by the liquid crystal panel 120 retains high directionality, and a divergence angle thereof, due to influence by scattering properties of a liquid crystal material, is slightly larger than the divergence angle of the light beam from the backlight module 110, which may be ±2.5°, ±3.5°, or +5.5°. A light ray modulated carries positional and angular information of the light field.

In some examples, a resolution of the liquid crystal panel 120 is at least 1920×1080 pixels, e.g., 1920×1080 pixels, 2460×1080 pixels, 3840×2160 pixels, 7680×4320 pixels, or 15360×8640 pixels. In some examples, a size of the liquid crystal panel 120 is at least 6 inches, e.g., 6.8 inches, 10.1 inches, 15.6 inches, 27 inches, or 31.5 inches. In some examples, a pixel density of the liquid crystal panel 120 may be 279 PPI, 396 PPI, 403 PPI, or 653 PPI.

In an example where the directional light-emitting 2D display screen 100 emits light in an active manner, the directional light-emitting 2D display screen 100 includes a display layer and a light beam directing layer, where the display layer is configured to display images and emit light rays with a large divergence angle, and the light beam directing layer is integrated on one side of a light-emitting surface of the display layer and is configured to converge, direct, collimate, and homogenize light rays, which achieves high directionality, an extremely small divergence angle, and high uniformity, where the divergence angle of light beam may be +2°, ±3°, or ±5°, and the uniformity of light beam may be 90%, 95%, or 98%.

In some examples, the display layer is selected from any one of an LED display panel, a MicroLED display panel, an AMOLED display panel, or an OLED display panel with a small pixel unit spacing, and each sub-pixel of the display layer is configured to achieve active emission through electroluminescence or an inorganic semiconductor, without need for an additional backlight module. A plurality of sub-pixels are periodically arranged on the display layer, and a plurality of sub-pixels of different colors collectively form a single color pixel. In some examples, colors of the sub-pixels are red (R), green (G), and blue (B), that is, each pixel is composed of sub-pixels of RGB. In some alternative examples, colors of the sub-pixels may be red (R), green (G), blue (B), and white (W), that is, each pixel is composed of sub-pixels of RGBW.

In some examples, the light beam directing layer is integrated on one side of a light-emitting surface of the display layer, including the micro-lens array 112 and the freeform surface lens array 113 as shown in FIG. 3, and as described above, the micro-lens array 112 and the freeform surface lens array 113 form a two-stage optical modulation structure. In some examples, the micro-lens array 112 is formed by a plurality of lens elements regularly arranged, and the lens elements may correspond to either a plurality of pixels or any individual pixel of the display layer. In some examples, the freeform surface lens array 113 is formed by a plurality of freeform surface lens elements regularly arranged, and the freeform surface lens elements may correspond to either a plurality of pixels or any individual pixel of the display layer.

As illustrated in FIG. 5, according to an example of the present disclosure, the lenticular lens array 200 is placed aslant relative to the directional light-emitting 2D display screen 100. As shown in the figure, the lenticular lens array 200 is closely attached to a surface of the directional light-emitting 2D display screen 100, i.e., a surface of the liquid crystal panel 120, and forms an inclination angle q with the directional light-emitting 2D display screen 100, where a range of the inclination angle q is −45°≤q<0° or 0°<q<45°. Inclination of the lenticular lens array 200 relative to pixel columns of the directional light-emitting 2D display screen 100 helps to avoid Moire fringes and enlarge a viewing angle. An accuracy of alignment between the lenticular lens array 200 and the directional light-emitting 2D display screen 100 is determined by a fitting accuracy and a software image correction algorithm.

In some examples, the lenticular lens array 200 is formed by arranging a plurality of the lenticular lens elements 210 at an equal interval in a one-dimensional direction. In some examples, the one-dimensional direction may be a horizontal direction along an x-axis or a vertical direction along a y-axis. The lenticular lens array 200 shown in FIG. 5 is formed by arranging a plurality of the lenticular lens elements 210 at an equal interval in the horizontal direction along the x-axis. In some examples, a single lenticular lens element 210 covers at least 10 sub-pixels in the horizontal direction along the x-axis, e.g., 18 sub-pixels.

In some examples, the lenticular lens array 200 is monolithically integrated, and a cross-sectional surface profile of the lenticular lens elements 210 may be either a freeform surface (such as an XY polynomial surface) or an aspheric surface (such as an even-order polynomial surface) to eliminate optical aberrations. For example, a surface profile of the lenticular lens element 210 is an even-order rotationally symmetric aspheric surface with a maximum order of 32. Based on optical properties of curved surfaces of the lenticular lens elements 210, the lenticular lens array 200 performs deflection-based modulation of directional light rays incident from the directional light-emitting 2D display screen 100, such that light rays from different sub-pixels are emitted at predetermined angles, and a discrete light field distribution is spatially reconstructed. In the lenticular lens array 200 according to an example of the present disclosure, a plurality of light rays carrying information of the same 3D object point are first modulated by different lenticular lens elements 210 and then converge at a predetermined depth location to reconstruct a 3D image point, and a plurality of adjacent lenticular lens elements cooperate with each other to enlarge the viewing angle; and the lenticular lens array 200 is placed aslant relative to the directional light-emitting 2D display screen 100 to suppress Moire fringes, and a surface profile of each lenticular lens element is either an aspheric surface or a freeform surface to eliminate optical aberrations, which creates conditions for achieving light field 3D display with a high resolution, a large viewing angle, and a large depth range.

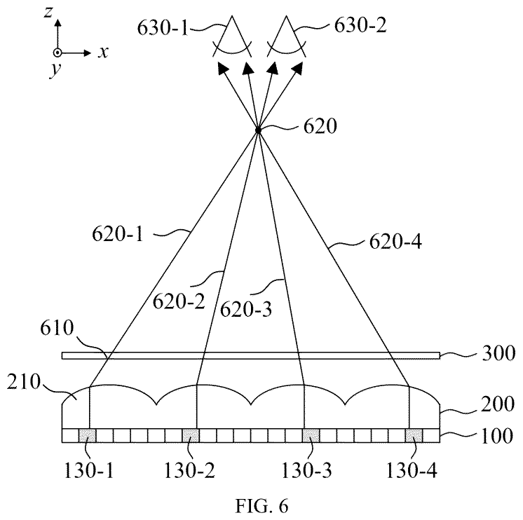

As shown in FIGS. 6-11B, the optical diffusion screen 300 is configured to perform small-angle diffusion of reconstructed light rays modulated by the lenticular lens array 200 in the one-dimensional direction, such that 3D images corresponding to a discrete light field become continuous. In some examples, a function distribution of light intensity modulation by the optical diffusion screen 300 is a Gaussian distribution or flat-top distribution, with a diffusion angle available only in the one-dimensional direction, and for example, the diffusion angle may be 3.5°, 5°, 6.5° or the like. Similarly, one-dimensional diffusion of light rays by the optical diffusion screen 300 may be either in the horizontal direction along the x-axis or in the vertical direction along the y-axis. In some examples, a direction of light diffusion through the optical diffusion screen 300 aligns with a direction of equidistant arrangement of the lenticular lens elements 210.

In an example in which the lenticular lens elements 210 of the lenticular lens array 200 are horizontally arranged in the one-dimensional direction and the optical diffusion screen 300 performs one-dimensional horizontal diffusion of light rays incident from the lenticular lens array 200, functional principles of the optical diffusion screen 300 are illustratively explained. Light rays modulated by the lenticular lens array 200 are discretely distributed (resembling a dot matrix), micro gaps exist between adjacent 3D image points, and direct display causes human eyes to perceive an image composed of numerous separated light spots, which resembles “pixel graininess” of a low-resolution display. According to an example of the present disclosure, the optical diffusion screen 300 performs small-angle diffusion of light rays in the horizontal direction of arranging the lenticular lens elements, the light propagation direction remains unaffected in the vertical direction, and small-angle horizontal diffusion eliminates the gaps between adjacent 3D image points, and avoids discreteness perception and excessive blurriness. An original resolution is maintained due to absence of diffusion in the vertical direction, which prevents image blur, such that further processing of light rays through the optical diffusion screen 300 causes continuous presentation of 3D images corresponding to the discrete light field.

Consequently, a plurality of highly-directional light rays emitted from the directional light-emitting 2D display screen 100, after propagation direction modulation by each lenticular lens element 210 of the lenticular lens array 200, converge at a focal point of each lenticular lens element 210, and then undergo small-angle diffusion in the horizontal direction and continue to propagate forward after passing through the optical diffusion screen 300. When the light rays converge at the focal points of the lenticular lens elements 210, an average horizontal size (along the x-axis) of image patches projected onto a lower surface of the optical diffusion screen 300 is 0.01 mm, which is smaller than a horizontal size of a single sub-pixel. After diffusion by the optical diffusion screen 300, the horizontal size of image patches along the x-axis is enlarged, but is smaller than a pitch of the lenticular lens array 200, thereby achieving a high resolution and a large depth range.

In a second aspect, the present disclosure provides a light field 3D display method, including: a plurality of first light rays are emitted from the directional light-emitting 2D display screen 100, where the plurality of first light rays form a light beam with a first divergence angle; the lenticular lens array 200 is configured to directionally modulate the plurality of first light rays emitted by the directional light-emitting 2D display screen 100, and the plurality of first light rays converge at a focal point of each lenticular lens element 210 of the lenticular lens array 200, to form a plurality of second light rays that reconstruct a discrete light field; and the optical diffusion screen 300 is configured to diffuse the plurality of second light rays in a one-dimensional direction to form a light beam with a second divergence angle, such that 3D images corresponding to the discrete light field become spatially continuous, where the second divergence angle is 3.5°, 5°, or 6.5°, and preferably, the second divergence angle is 5°.

In some examples, light rays emitted from the directional light-emitting 2D display screen 100, after direction modulation by the lenticular lens array 200, precisely converge at a focal point of each lenticular lens element 210, resulting in a small image patch size, and then undergo small-angle diffusion in the one-dimensional direction and continue to propagate forward after passing through the optical diffusion screen 300. Light rays from different directions carrying information of a same 3D image point, converge at a reproduction position corresponding to the 3D image point, and continue to propagate forward, to reconstruct a complete discrete light field. The light field is directly perceived monocularly after being discretely reconstructed. For a single 3D image point, at least two light rays from different directions are received monocularly, to provide depth cues for monocular focus adjustment. In some examples, a width of image patches on an incident surface of the optical diffusion screen 300 is less than a width of the sub-pixels 130 of the directional light-emitting 2D display screen 100, and a width direction of the image patches on the incident surface of the optical diffusion screen 300 aligns with an array direction of the lenticular lens array 200; and the width of image patches on the light-emitting surface of the optical diffusion screen 300 is less than or equal to the pitch of the lenticular lens array 200, and the width direction of the image patches on the light-emitting surface of the optical diffusion screen 300 aligns with the array direction of the lenticular lens array 200. In other words, when light rays converge at a focal point of each lenticular lens element 210, a one-dimensional size of image patches projected onto the lower surface of the optical diffusion screen 300 in the direction of equidistant arrangement of the lenticular lens elements 210 is smaller than a one-dimensional size of a single sub-pixel 130 in the same direction, and after diffusion by the optical diffusion screen 300, the one-dimensional size of image patches in the direction of equidistant arrangement of the lenticular lens elements 210 is less than or equal to the pitch of the lenticular lens elements 210.

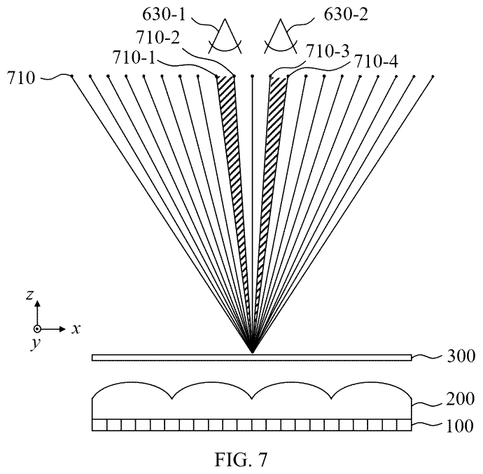

In some examples, as shown in FIG. 7, the directional light-emitting 2D display screen 100 is loaded with a 3D image source, a resolution of the 3D image source is identical to a resolution of the directional light-emitting 2D display screen 100, the 3D image source includes a plurality of combinations of the sub-pixels 130 with different intensity values, and light rays formed by the plurality of combinations of the sub-pixels 130 converge at predetermined specified distances to form a plurality of viewpoints 710, where the viewpoints 710 are arrayed at an equal interval; and a spacing between adjacent viewpoints 710 is less than an average pupil diameter, such that a pupil receives information from at least two viewpoints 710 simultaneously, thereby providing depth cues for monocular focus adjustment. All the viewpoints 710 are traversed, each of the viewpoints 710 corresponds to a light ray, and the light rays collectively partition the sub-pixels 130 into a plurality of image elements 810; each of the image elements 810 corresponds to at least two lenticular lens elements 210 in the array direction of the lenticular lens array 200; each of the image elements 810 corresponds to at least two rows of pixels or at least two columns of sub-pixels of the directional light-emitting 2D display screen 100 in a vertical array direction of the lenticular lens array 200; and each sub-pixel 130 of the image element 810 is arranged at varying distances from a same edge of a corresponding lenticular lens element 210.

Alternatively, the 3D image source is obtained by encoding positional and directional information of the light field collected from different viewpoints, and is presented as a combination of the sub-pixels 130 with different intensity values, each of the sub-pixels 130 corresponds to a light ray propagating in a certain direction of the light field, and a set of light rays that converge at a predefined specified distance form a viewpoint 710, where the viewpoints 710 are arranged at an equal interval in the one-dimensional direction. A light ray corresponds to each of the viewpoints 710, all the viewpoints 710 are traversed to obtain a set of light rays, and all the sub-pixels 130 corresponding to a set of light rays form an image element 810. Each of the image elements 810 corresponds to a plurality of the lenticular lens elements 210 in the direction of equidistant arrangement of the lenticular lens elements 210, and contains a plurality of rows or columns of pixels or the sub-pixels 130 in a direction perpendicular to the direction of equidistant arrangement of the lenticular lens elements 210. In the image element 810, each of the sub-pixels 130 exhibits a different positional relationship with a same edge of a corresponding lenticular lens element 210. The number of the sub-pixels 130 contained in each of the image elements 810 is identical to a total number of the viewpoints 710.

Alternatively, a one-dimensional spacing between the adjacent viewpoints 710 is less than an average monocular pupil diameter. A single eye simultaneously receives information of at least two viewpoints 710, which provides depth cues for monocular focus adjustment.

In some examples, each of the image elements 810 corresponds to at least two lenticular lens elements 210 in the direction of equidistant arrangement of the lenticular lens elements 210.

In some examples, each of the image elements 810 contains at least two rows or two columns of the sub-pixels 130 or pixels in the direction perpendicular to the direction of equidistant arrangement of the lenticular lens elements 210.

In some examples, a video loaded on the directional light-emitting 2D display screen 100 is continuously synthesized from a plurality of frames of images, and each frame of image represents a 3D image source.

FIG. 6 illustrates a side view of a discrete light field distribution reconstructed by a light field 3D display apparatus according to an example of the present disclosure. Taking an object point S as an example, a corresponding 3D image point is represented by S′620, the sub-pixels 130-1, 130-2, 130-3, and 130-4 carry positional and directional information of light rays emitted from the object point S, and after modulation of the light rays emitted, four reconstructed light rays 620-1, 620-2, 620-3, and 620-4 are emitted from different directions, converge at the 3D image point S′620, and continue to propagate forward, to reconstruct a discrete light intensity distribution on a surface of the 3D image point S′620, which is directly perceived monocularly. The reconstructed light rays 620-3 and 620-4 enter a left eye 630-1, and the reconstructed light rays 620-1 and 620-2 enter a right eye 630-2. For the 3D image point S′620, two light rays from different directions are received monocularly, to provide depth cues for monocular focus adjustment.

FIG. 7 is a side view of viewpoint arrangement according to an example of the present disclosure. The viewpoints 710 are densely arranged at an equal interval in a one-dimensional horizontal direction. At a predetermined specified distance, the spacing between adjacent viewpoints 710 is less than an average pupil diameter (3.0 mm) of the left eye 630-1 or the right eye 630-2. The left eye 630-1 simultaneously receives information from the viewpoints 710-1 and 710-2, and the right eye 630-2 simultaneously receives information from the viewpoints 710-3 and 710-4, which provides depth cues for monocular focus adjustment. An index difference of the viewpoints received by the left eye 630-1 and the right eye 630-2 is at least two, e.g., 3. All the viewpoints collectively form a viewing area, and in the viewing area, one or more persons may simultaneously view a correct 3D image.

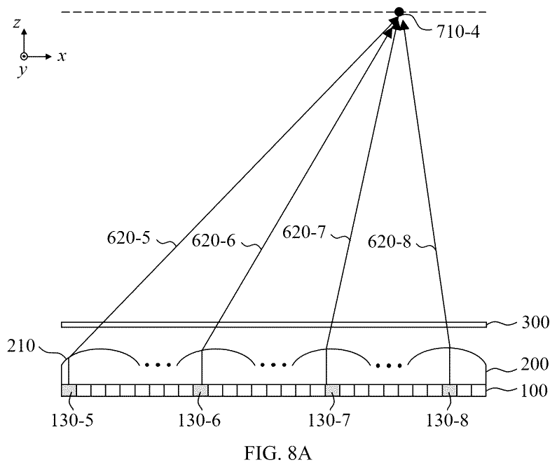

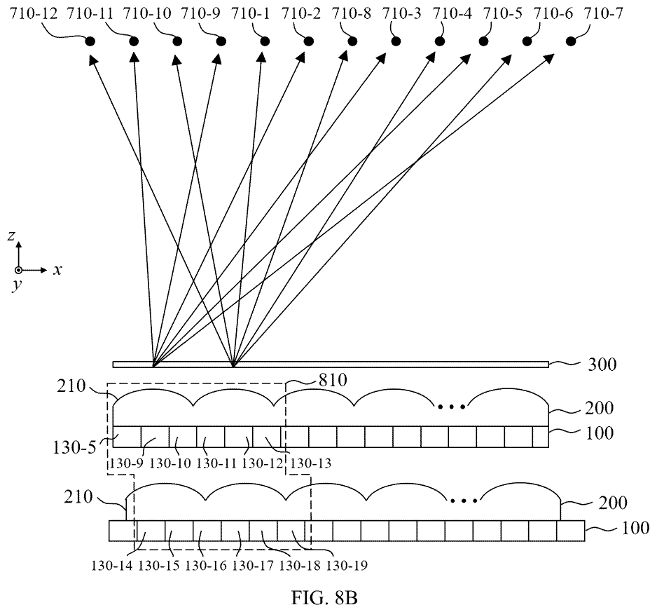

FIG. 8A is a side view illustrating correspondence between a single viewpoint and a sub-pixel according to an example of the present disclosure. A combination of the sub-pixels 130 with different intensity values forms an image loaded on the directional light-emitting 2D display screen 100, and specifically refers to a 3D image source. The resolution of the 3D image source is fully identical to the resolution of the directional light-emitting 2D display screen 100, e.g., 1920×1080 pixels, 2460×1080 pixels, 3840×2160 pixels, 7680×4320 pixels, 15360×8640 pixels, or the like. The 3D image source is obtained by encoding positional and directional information of the light field collected from different viewpoints. Each of the sub-pixels 130 corresponds to a light ray propagating in a certain direction of the light field, and a set of light rays that converge at a predefined specified distance form a viewpoint. For example, in FIG. 8A, the sub-pixels 130-5, 130-6, 130-7, and 130-8 correspond to reconstructed light rays 620-5, 620-6, 620-7, and 620-8 propagating in a direction of the light field, and the four light rays form a viewpoint 710-4.

FIG. 8B is a schematic diagram of sub-pixels contained in a single image element according to an example of the present disclosure. A light ray corresponds to each of the viewpoints, and all the viewpoints are traversed. For example, 12 light rays corresponding to the viewpoints numbered from 710-1 to 710-12 form a set of light rays, two rows of the sub-pixels 130-5 and 130-9 to 130-19 corresponding to the set of light rays collectively form an image element 810, and the image elements 810 are periodically arranged in the 3D image source.

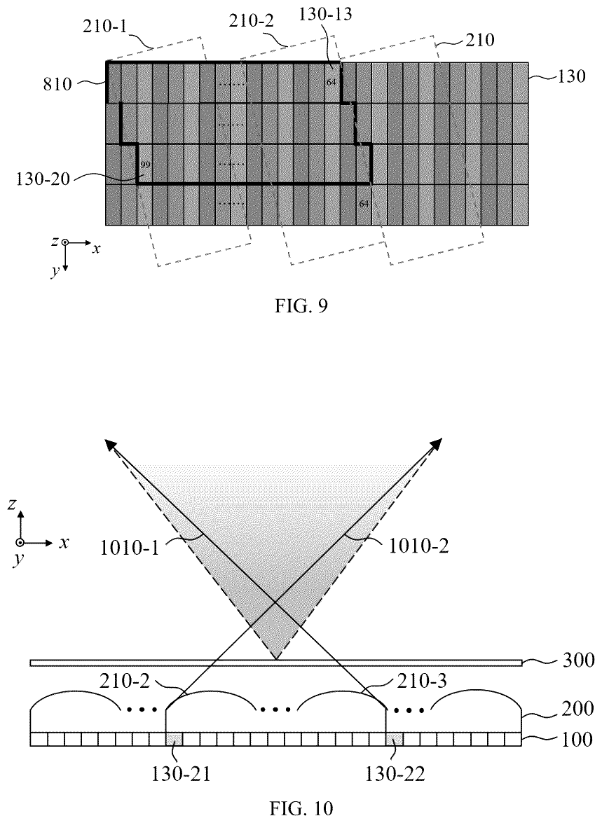

FIG. 9 is a top view illustrating correspondence between an image element and a lenticular lens element according to an example of the present disclosure. The image element 810 corresponds to six lenticular lens elements 210 (containing a total of 112 sub-pixels) in the horizontal direction along the x-axis, and contains two rows of pixels in the vertical direction along the y-axis, where a total number of the sub-pixels is 222 and is identical to a total number of the viewpoints. In the image element 810, each of the sub-pixels 130 exhibits a different positional relationship with a corresponding lenticular lens element 210 in a left edge, which corresponds to light rays that form different viewpoints. For example, the sub-pixels 130-13 and 130-20 are different from corresponding lenticular lens elements 210-1 and 210-2 in offsets, which respectively correspond to light rays that form the viewpoints 99 and 64.

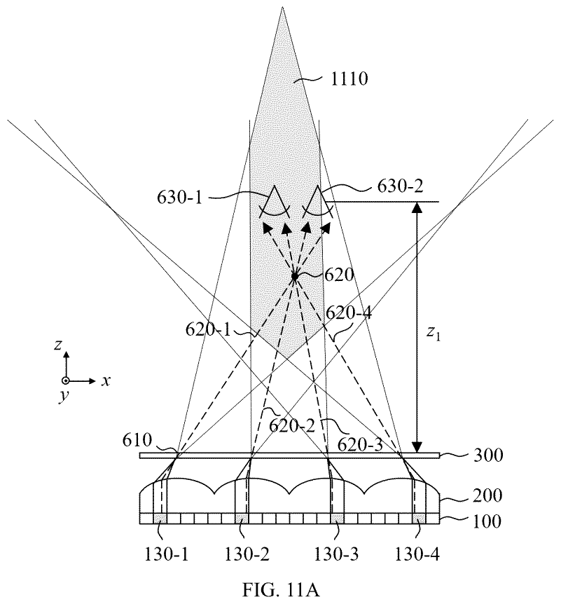

FIG. 10 is a side view of a viewing-angle range according to an example of the present disclosure. A single image element 810 covers six lenticular lens elements 210 in the one-dimensional horizontal direction, two sub-pixels 130-21 and 130-22 are farthest and closest to the left edge of the lenticular lens element 210, and emitted highly-directional light rays, after directional modulation by two different lenticular lens elements 210-2 and 210-3 and small-angle diffusion by the optical diffusion screen 300 in the one-dimensional horizontal direction, are modulated in a left edge direction 1010-1 and a right edge direction 1010-2 respectively. An angle between the direction 1010-1 and the direction 1010-2 formed along the optical diffusion screen 300 is a viewing angle of the light field 3D display apparatus. Different side information of an object is viewed at different angular positions in the viewing range, which enables to simultaneously provide cues for monocular motion parallax and binocular parallax.

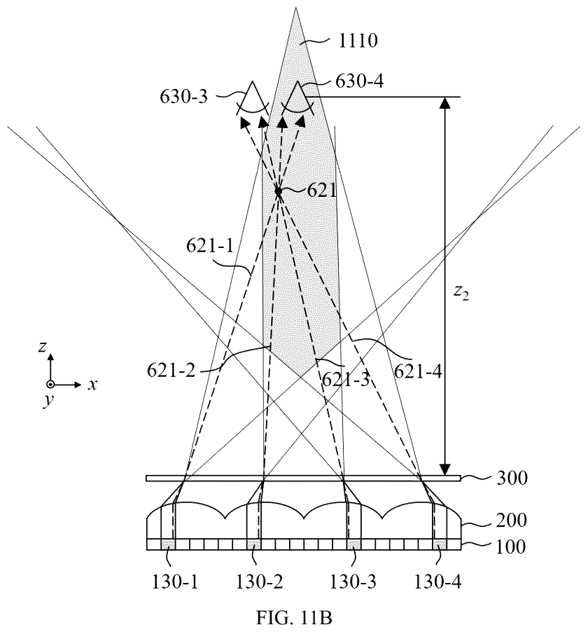

FIG. 11 is a side view of reconstructed light rays received by a viewer at different depth positions according to an example of the present disclosure. The sub-pixels of the directional light-emitting 2D display screen 100 have certain sizes, the sub-pixels 130-1, 130-2, 130-3, and 130-4 carry light field information of the same object point S, the highly-directional light rays emitted by the four sub-pixels converge at a focal point 610 of each lenticular lens element of the lenticular lens array 200 and continue to propagate forward, and after the small-angle diffusion by the optical diffusion screen 300 in the one-dimensional horizontal direction, reconstructed light rays in a certain range are obtained. A convergence region of the reconstructed light rays is a reconstructed region 1110 of the 3D image point S′. FIG. 11A is a side view of light rays received by a viewer I at a depth z₁ according to an example of the present disclosure. In this case, the left eye 630-1 receives the reconstructed light rays 620-3 and 620-4, the right eye 630-2 receives the reconstructed light rays 620-1 and 620-2, and the four reconstructed light rays correspond to the reconstructed 3D image point S′620. FIG. 11B is a side view of light rays received by a viewer II at a depth z₂ according to an example of the present disclosure. In this case, a left eye 630-3 of the viewer II receives the reconstructed light rays 621-3 and 621-4, the right eye 630-4 receives the reconstructed light rays 621-1 and 621-2, and the four reconstructed light rays correspond to the reconstructed 3D image point S′621. Both the 3D image points S′620 and 621 are located inside the reconstructed region 1110 of the 3D image point S′, carrying information of the 3D image point S′. At the depth z₁ or z₂, a single eye of the viewer receives two reconstructed light rays from the 3D image point S′ from different directions, and therefore, the light field 3D display apparatus provided by the present disclosure is not limited in viewing distances, and allows a plurality of viewers to properly view at any distance (near or far) simultaneously.

The light field 3D display apparatus and a light field 3D display method provided by the present disclosure have the advantages of a large viewing angle, a high resolution, and a large depth range, without limitations in viewing distances, and allow a plurality of viewers to view simultaneously, which ensures that human eyes perceive stereoscopic property properly in the viewing-angle range through cues for monocular focus adjustment, monocular motion parallax, and binocular parallax. Additionally, the light field 3D display apparatus of this technical solution achieves a high level of integration of components through use of the directional light-emitting 2D display screen, the lenticular lens array, and the optical diffusion screen.

The terms “including”, “comprising”, or any other variants are intended to cover the non-exclusive inclusions, including not only those elements listed but also other elements that are not listed explicitly.

The terms “front”, “rear”, “upper”, “lower”, “left”, “right” and other positional terms mentioned herein are defined based on positions of components illustrated in the accompanying drawings and mutual orientations thereof, and are intended solely for clarity and convenience of expressing the technical solution. It should be understood that use of these positional terms is not intended to limit the scope of protection of the present disclosure.

The above are merely preferred examples of the present disclosure, and should not be construed to limit the scope of protection of the present disclosure, and therefore, all equivalent variations made within the patent scope of the present disclosure still belong to the protection scope of the present disclosure.

What is claimed is:

1. A light field 3D display apparatus, comprising:
a directional light-emitting 2D display screen arranged at a bottom layer of the light field 3D display apparatus, wherein the directional light-emitting 2D display screen is configured to emit a plurality of first light rays, and the plurality of first light rays carry positional and directional information of a light field, and form a light beam with a first divergence angle;
a lenticular lens array, wherein the lenticular lens array is attached to one surface of the directional light-emitting 2D display screen, and placed aslant relative to the directional light-emitting 2D display screen, and the lenticular lens array is configured to directionally modulate the plurality of first light rays emitted by the directional light-emitting 2D display screen, to form a plurality of second light rays that reconstruct a discrete light field; and
an optical diffusion screen arranged on the other side of the lenticular lens array, wherein the optical diffusion screen is configured to diffuse the plurality of second light rays in a one-dimensional direction to form a light beam with a second divergence angle, such that 3D images corresponding to the discrete light field become spatially continuous.

2. The light field 3D display apparatus according to claim 1, wherein the first divergence angle is any one of ±2°, ±3°, and +5°, and the second divergence angle is any one of 3.5°, 5°, and 6.5°.

3. The light field 3D display apparatus according to claim 1, wherein the directional light-emitting 2D display screen emits light in a passive manner, and the directional light-emitting 2D display screen emitting light in the passive manner comprises:
a backlight module, wherein the backlight module comprises a light source layer, a micro-lens array, and a freeform surface lens array that are sequentially arranged, a surface profile of a lens element of the micro-lens array is selected from any one of a freeform surface and an aspheric surface, and a surface profile of a lens element of the freeform surface lens array is selected from any one of a freeform surface and a freeform Fresnel surface; and
a liquid crystal panel, wherein the liquid crystal panel comprises a plurality of sub-pixels arranged in a rectangular and strip-shaped manner, each of the plurality of sub-pixels has a color selected from any one of red, green, blue, and white, and a plurality of sub-pixels of different colors collectively form a single color pixel of the liquid crystal panel.

4. The light field 3D display apparatus according to claim 1, wherein the directional light-emitting 2D display screen emits light in an active manner, and the directional light-emitting 2D display screen emitting light in the active manner comprises:
a display layer, wherein a plurality of sub-pixels are arranged on the display layer, the sub-pixels are configured to achieve active emission through electroluminescence or an inorganic semiconductor, each of the plurality of sub-pixels has a color selected from any one of red, green, blue, and white, and a plurality of sub-pixels of different colors collectively form a single color pixel of the display layer; and
a light beam directing layer integrated on one side of a light-emitting surface of the display layer, wherein the light beam directing layer comprises a micro-lens array and a freeform surface lens array that are sequentially arranged, and a lens element in the micro-lens array or the freeform surface lens array is arranged to correspond to a plurality of pixels or an individual pixel of the display layer.

5. The light field 3D display apparatus according to claim 1, wherein the lenticular lens array is formed by arranging a plurality of lenticular lens elements at an equal interval in a one-dimensional direction, and a cross-sectional surface profile of the lenticular lens element is a freeform surface or an aspheric surface.

6. The light field 3D display apparatus according to claim 5, wherein a function distribution of light intensity modulation by the optical diffusion screen is a Gaussian distribution or flat-top distribution, and a direction of diffusing the plurality of second light rays through the optical diffusion screen aligns with a direction of arranging the lenticular lens elements on the lenticular lens array.

7. A light field 3D display method, comprising:
a plurality of first light rays are emitted from the directional light-emitting 2D display screen, wherein the plurality of first light rays form a light beam with a first divergence angle, and the first divergence angle is any one of +2°, ±3°, and ±5°;
the lenticular lens array is configured to directionally modulate the plurality of first light rays emitted by the directional light-emitting 2D display screen, and the plurality of first light rays converge at a focal point of each lenticular lens element of the lenticular lens array, to form a plurality of second light rays that reconstruct a discrete light field, wherein the lenticular lens array is placed aslant relative to the directional light-emitting 2D display screen, and the lenticular lens array is formed by arranging a plurality of lenticular lens elements at an equal interval in the one-dimensional direction; and
the optical diffusion screen is configured to diffuse the plurality of second light rays in the one-dimensional direction to form a light beam with a second divergence angle, such that 3D images corresponding to the discrete light field become spatially continuous, and a direction of diffusing the plurality of second light rays through the optical diffusion screen aligns with a direction of arranging the lenticular lens elements on the lenticular lens array.

8. The light field 3D display method according to claim 7, wherein a width of image patches on an incident surface of the optical diffusion screen is less than a width of the sub-pixels of the directional light-emitting 2D display screen, and a width direction of the image patches on the incident surface of the optical diffusion screen aligns with an array direction of the lenticular lens array; and the width of image patches on the light-emitting surface of the optical diffusion screen is less than or equal to a pitch of the lenticular lens array, and the width direction of the image patches on the light-emitting surface of the optical diffusion screen aligns with the array direction of the lenticular lens array.

9. The light field 3D display method according to claim 7, wherein the directional light-emitting 2D display screen is loaded with a 3D image source, a resolution of the 3D image source is identical to a resolution of the directional light-emitting 2D display screen, the 3D image source comprises a plurality of combinations of the sub-pixels with different intensity values, and light rays formed by the plurality of combinations of the sub-pixels converge at predetermined specified distances to form a plurality of viewpoints, wherein the viewpoints are arrayed at an equal interval;
and a spacing between adjacent viewpoints is less than an average pupil diameter, such that a pupil receives information from at least two viewpoints simultaneously, thereby providing depth cues for monocular focus adjustment.

10. The light field 3D display method according to claim 9, wherein all the viewpoints are traversed, each of the viewpoints corresponds to a light ray, and the light rays collectively partition the sub-pixels into a plurality of image elements; each of the image elements corresponds to at least two lenticular lens elements in the array direction of the lenticular lens array; each of the image elements corresponds to at least two rows of pixels or at least two columns of sub-pixels of the directional light-emitting 2D display screen in a vertical array direction of the lenticular lens array; and each sub-pixel of the image element is arranged at varying distances from a same edge of a corresponding lenticular lens element.
